(19) United States
(12) Patent Application Publication
(10) Pub. No.: US 2024/0344664 A1
(43) Pub. Date: Oct. 17, 2024

(54) PURGE CONTAINER AND METHOD OF USING THE PURGE CONTAINER

(71) Applicants: EBARA CORPORATION, Tokyo (JP); KAWASAKI JUKOGYO KABUSHIKI KAISHA, Kobe-shi, Hyogo (JP)

(72) Inventors: Shuichiro HONDA, Tokyo (JP); Tetsuji KASATANI, Tokyo (JP); Hayato IKEDA, Tokyo (JP); Mitsutaka IWAMI, Tokyo (JP); Asaki SUZUKI, Tokyo (JP); Koichiro YAMANOUCHI, Kobe-shi, Hyogo (JP); Yuya YAMANE, Kobe-shi, Hyogo (JP); Yuichi EMI, Kobe-shi, Hyogo (JP); Tomonori TAKASE, Kobe-shi, Hyogo (JP); Akihiko INOMATA, Kobe-shi, Hyogo (JP)

(21) Appl. No.: 18/682,207

(22) PCT Filed: Aug. 9, 2022
(86) PCT No.: PCT/JP2022/030383

§ 371 Date: Feb. 8, 2024

(30) Foreign Application Priority Data
Aug. 17, 2021 (JP) 2021-132921

(51) Int. Cl. F17C 9/00

(52) U.S. Cl. CPC F17C 9/00; F17C 2201/0104; F17C 2201/032; F17C 2201/052; F17C 2203/0333; F17C 2203/0391; F17C 2205/0323; F17C 2221/012; F17C 2223/0153; F17C 2223/047; F17C 2227/0142; F17C 2227/0178; F17C 2227/044; F17C 2250/0439; F17C 2250/0491

(57) ABSTRACT

A purge container (1) has a container body (21) having an interior space (20) for accommodating a submersible pump (2), an upper lid (23) configured to cover an upper opening of the container body (21), a lower lid (24) configured to cover a lower opening of the container body (21), and a purge-gas inlet port (27) and a purge-gas outlet port (28) communicating with the interior space (20) of the container main body (21). The container body (21) is secured to an upper portion of a pump column (3) in which the submersible pump (2) is to be installed.

### TECHNICAL FIELD

The present invention relates to a purge container for exposing a submersible pump for pressurizing liquefied gas, such as liquefied natural gas (LNG) or liquid hydrogen, to a purge gas. Further, the present invention relates to a method of exposing a submersible pump to purge gas using such a purge container.

### BACKGROUND ART

Natural gas is widely used for thermal power generation and used as a raw material for chemicals. Furthermore, hydrogen is expected to be an energy that does not generate carbon dioxide that causes global warming. Applications of hydrogen as energy include fuel cell and turbine power generation. Natural gas and hydrogen are in a gaseous state at normal temperature, and therefore natural gas and hydrogen are cooled and liquefied for their storage and transportation. Liquefied gas, such as liquefied natural gas (LNG) and liquefied hydrogen, is temporarily stored in a liquefied-gas storage tank and then delivered to a power plant, factory, or the like by a pump.

FIG. 22 is a schematic view showing a conventional example of a liquefied-gas storage tank in which liquefied gas is stored and a pump for pumping up the liquefied gas. A pump 500 is installed in a vertical pump column 505 disposed in a liquefied-gas storage tank 501. An inside of the pump column 505 is filled with the liquefied gas, and the entire pump 500 is immersed in the liquefied gas. The pump 500 is thus a submersible pump that can operate in the liquefied gas. When the pump 500 is operated, the liquefied gas in the liquefied-gas storage tank 501 is sucked into the pump column 505, ascends in the pump column 505, and is discharged from the pump column 505 through a liquefied-gas discharge port 509.

### CITATION LIST

### Patent Literature

Patent document 1: Japanese Patent No. 3197645
Patent document 2: Japanese Patent No. 3198248
Patent document 3: Japanese Patent No. 3472379

### SUMMARY OF INVENTION

### Technical Problem

The pump 500 is a machine that contains consumables, and therefore the pump 500 requires regular maintenance. When the pump 500 is installed in the pump column 505 for the first time and when the pump 500 is returned to the pump column 505 after the maintenance, it is necessary to prevent air, entrained by the pump 500, from entering the pump column 505. If air enters the pump column 505 together with the pump 500, moisture in the air will be cooled and solidified by the ultra-low temperature liquefied gas, and as a result, the rotation of the pump 500 will be hindered. In particular, when the liquefied gas is liquid hydrogen, nitrogen and oxygen in the air are liquefied or solidified and may be mixed into the liquefied gas. The solidification of nitrogen and oxygen can damage equipment. Moreover, mixture the liquefied oxygen with the liquid hydrogen can cause an explosion.

When the pump 500 is removed from the pump column 505 for the purpose of maintenance or the like, it is also necessary to prevent ambient air from entering the pump column 505. Specifically, the pump 500 that has been in contact with the liquefied gas has an ultra-low temperature, and when the air contacts such low-temperature pump 500, the moisture contained in the air is liquefied or solidified on the surface of the pump 500, and may fall into the pump column 505 and mixed with the liquefied gas. In particular, when the liquefied gas is liquid hydrogen, following problems may occur. Specifically, the temperature of liquid hydrogen is −253° C. or less, and therefore the pump 500 just removed from the pump column 505 also has an ultra-low temperature equivalent to that of the liquid hydrogen. When the air comes into contact with such ultra-low temperature pump 500, not only the nitrogen but also the oxygen in the air is liquefied. If the liquefied oxygen drops into the liquefied-gas storage tank 501 and mixes with the liquid hydrogen, an explosion may occur, which is extremely dangerous.

Therefore, the present invention provides a purge container and a method of using the purge container capable of preventing entry of air when a submersible pump is carried into a pump column, and capable of warming the submersible pump when it is removed from the pump column to prevent components of the air from being liquefied.

### Solution to Problem

In an embodiment, there is provided a purge container for exposing a submersible pump to purge gas, the submersible pump being used to deliver liquefied gas, the purge container comprising: a container body having an interior space for accommodating the submersible pump therein, the container body being secured to an upper portion of a pump column in which the submersible pump is to be installed; an upper lid configured to cover an upper opening of the container body; a lower lid configured to cover a lower opening of the container body; and a purge-gas inlet port and a purge-gas outlet port communicating with the interior space of the container body.

In an embodiment, the purge container further comprises a side lid configured to close an opening formed in a side wall of the container body.

In an embodiment, the purge container further comprises: an inlet valve coupled to the purge-gas inlet port; and an outlet valve coupled to the purge-gas outlet port.

In an embodiment, the purge container further comprises a pump suspension mechanism removably attached to the upper lid, the pump suspension mechanism being configured to suspend the submersible pump within the interior space.

In an embodiment, the pump suspension mechanism includes a coupling member coupled to the submersible pump, and a stopper engaged with the coupling member, and the upper lid has a hole having a shape that does not allow the stopper to pass through the hole.

In an embodiment, the lower lid is configured to support the submersible pump.

In an embodiment, the lower lid is removably attached to the container body.

In an embodiment, the container body has a side wall with a heat-insulating structure.

In an embodiment, the lower lid is composed of a door structure, the purge container further comprises a door opening-closing device configured to open and close the door structure, and the door opening-closing device includes a door drive mechanism which is arranged in the interior space and coupled to the door structure.

In an embodiment, the purge container further comprises an inner elevating device configured to elevate and lower the submersible pump, the inner elevating device including a pump hoisting device arranged in the interior space.

In an embodiment, the lower lid is composed of a gate valve, and the purge container further comprises a gate-valve opening-closing device configured to open and close the gate valve.

In an embodiment, there is provided a method of using a purge container for exposing a submersible pump to purge gas, the submersible pump being used to deliver liquefied gas, the method comprising: accommodating the submersible pump in an interior space of a container body of the purge container which is secured to an upper portion of a pump column; and filling the interior space accommodating the submersible pump with purge gas.

In an embodiment, the liquefied gas comprises liquid hydrogen, and the purge gas comprises a gas having a boiling point lower than a boiling point of hydrogen.

In an embodiment, the method further comprises expelling the liquefied gas from the pump column before accommodating the submersible pump in the purge container.

In an embodiment, the method further comprises expelling the liquefied gas from the pump column after accommodating the submersible pump in the purge container.

In an embodiment, the method further comprises lowering the submersible pump from the purge container into the pump column by an elevating device.

In an embodiment, the method further comprises pulling up the submersible pump out of the pump column into the purge container by the elevating device while supplying purge gas into the interior space of the purge container.

In an embodiment, the method further comprises filling the interior space accommodating the submersible pump with purge gas after the submersible pump is pulling up into the purge container.

In an embodiment, the method further comprises removing the submersible pump from the purge container.

### Advantageous Effects of Invention

According to the present invention, the submersible pump is exposed to the purge gas in the purge container secured to the upper portion of the pump column, immediately before the submersible pump is moved into the pump column. Air and moisture entrained with the submersible pump are removed from the submersible pump by the purge gas, and as a result, the submersible pump is dried or deaerated (this operation will be hereinafter referred to as dry-up operation). Since this drying-up operation is performed directly above the pump column, the submersible pump can be rapidly moved into the pump column with the purge gas existing around the submersible pump after the drying-up operation. Therefore, the air and moisture are not entrained with the submersible pump, and the air and moisture are prevented from entering the pump column.

Furthermore, according to the present invention, the ultra-low temperature submersible pump can be warmed with the purge gas while being pulled out of the pump column into the purge container (this operation will hereinafter be referred to as hot-up operation). This hot-up operation is performed before the submersible pump contacts the ambient air, so that moisture in the air is not liquefied or solidified on the surfaces of the submersible pump. In particular, the present invention is effective when the liquefied gas is liquid hydrogen. Specifically, the submersible pump that has been immersed in liquid hydrogen has an ultra-low temperature equivalent to that of liquid hydrogen when the submersible pump is pulled out of the pump column. The boiling point of hydrogen (−253° C.) is lower than the boiling point of oxygen (−183° C.) and the boiling point of nitrogen (−196° C.). Therefore, when the air comes into contact with the submersible pump immediately after the submersible pump is pulled out of the pump column, not only nitrogen in the air but also oxygen is liquefied and may drop into the pump column. In this regard, according to the present invention, the submersible pump that has been immersed in liquid hydrogen is rapidly warmed by the purge gas before the submersible pump contacts the air. Therefore, when the air comes into contact with the submersible pump, the oxygen and nitrogen in the air are not liquefied, and thus the liquefied oxygen and liquefied nitrogen do not drop into the pump column. As a result, safe removal of the submersible pump can be achieved.

### BRIEF DESCRIPTION OF DRAWINGS

FIG. 1 is a schematic view for illustrating an operation of exposing a submersible pump to purge gas in a purge container before the submersible pump is installed in a pump column;

FIG. 2 is a cross-sectional view showing an embodiment of the purge container;

FIG. 3 illustrates an embodiment of a method of exposing the submersible pump to purge gas using the purge container;

FIG. 4 illustrates an embodiment of a method of exposing the submersible pump to purge gas using the purge container;

FIG. 5 illustrates an embodiment of processes of pulling up the submersible pump out of the pump column;

FIG. 6 illustrates an embodiment of processes of pulling up the submersible pump out of the pump column;

FIG. 7 is a cross-sectional view showing another embodiment of the purge container;

FIG. 8 illustrates an embodiment of a method of exposing the submersible pump to purge gas using the purge container shown in FIG. 7;

FIG. 9 illustrates an embodiment of a method of exposing the submersible pump to purge gas using the purge container shown in FIG. 7;

FIG. 10 illustrates an embodiment of processes of pulling up the submersible pump out of the pump column;

FIG. 11 illustrates an embodiment of processes of pulling up the submersible pump out of the pump column;

FIG. 12 is a cross-sectional view showing still another embodiment of the purge container;

FIG. 13 illustrates an embodiment of a method of exposing the submersible pump to purge gas using the purge container shown in FIG. 12;

FIG. 14 illustrates an embodiment of a method of exposing the submersible pump to purge gas using the purge container shown in FIG. 12;

FIG. 15 illustrates an embodiment of a method of exposing the submersible pump to purge gas using the purge container shown in FIG. 12;

FIG. 16 illustrates an embodiment of processes for pulling up the submersible pump out of the pump column using the purge container shown in FIG. 12;

FIG. 17 illustrates an embodiment of processes for pulling up the submersible pump out of the pump column using the purge container shown in FIG. 12;

FIG. 18 is a cross-sectional view showing still another embodiment of the purge container;

FIG. 19 illustrates the purge container when a gate valve shown in FIG. 18 is opened;

FIG. 20 is a cross-sectional view showing still another embodiment of the purge container;

FIG. 21 illustrates the purge container when a gate valve shown in FIG. 20 is opened; and

FIG. 22 is a schematic view showing a conventional example of a liquefied-gas storage tank in which liquefied gas is stored and a pump for pumping up the liquefied gas.

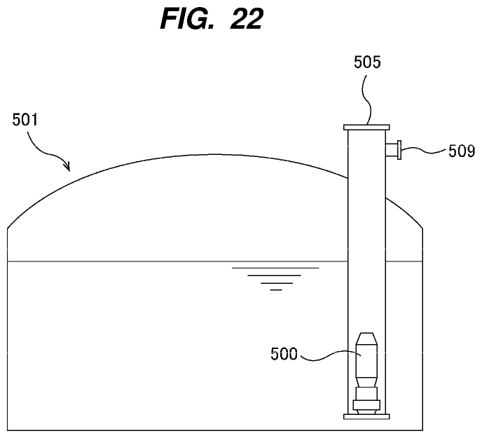

### DESCRIPTION OF EMBODIMENTS

Hereinafter, embodiments of the present invention will be described with reference to the drawings.

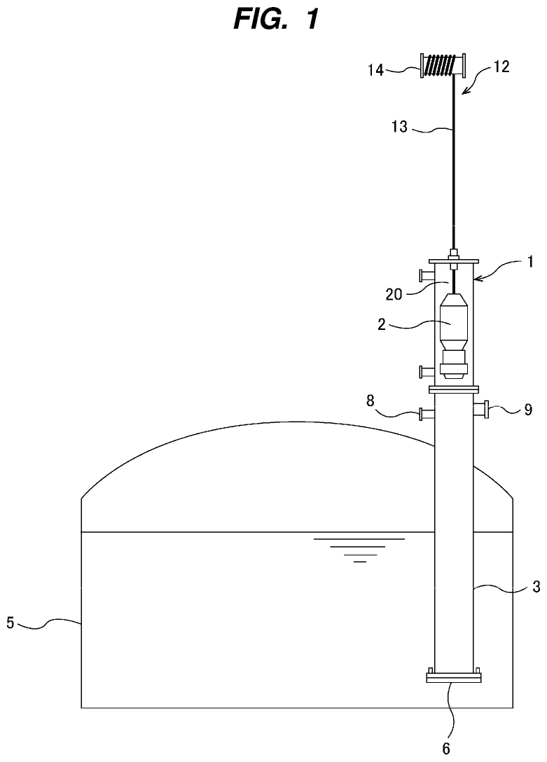

FIG. 1 is a schematic view for illustrating an operation of exposing a submersible pump to purge gas in a purge container before the submersible pump is installed in a pump column. A purge container 1 is a device for exposing a submersible pump 2 to purge gas. The submersible pump 2 is used for delivering liquefied gas, such as liquefied natural gas (LNG), or liquid hydrogen. Examples of the liquefied gas include liquefied ammonia, liquid hydrogen, liquid nitrogen, liquefied natural gas, liquefied ethylene gas, and liquefied petroleum gas. The purge container 1 is secured to an upper portion of a pump column 3. The purge container 1 is configured to accommodate the submersible pump 2 therein.

As shown in FIG. 1, the pump column 3 is installed in a liquefied-gas storage tank 5 in which the liquefied gas, such as liquefied natural gas (LNG) or liquid hydrogen, is stored. The pump column 3 is a vertically extending hollow container, and its upper part protrudes upward from the liquefied-gas storage tank 5. A suction valve 6 is provided at a bottom of the pump column 3. The submersible pump 2 is installed on the bottom of the pump column 3. The structure of the suction valve 6 is not particularly limited. For example, the suction valve 6 may be of a type in which the suction valve 6 is opened by the weight of the submersible pump 2, or may be an actuator-driven valve (for example, an electric valve).

As shown in FIG. 1, the submersible pump 2 is coupled to a cable 13 of an elevating device 12. The submersible pump 2 is elevated and lowered by the elevating device 12. The elevating device 12 has a take-up device 14, such as a hoist or a winch, for hoisting the cable 13.

The purge gas is supplied into the purge container 1 when the submersible pump 2 is located in the purge container 1. An interior space 20 of the purge container 1 is filled with the purge gas, and the submersible pump 2 is exposed to the purge gas (i.e., the submersible pump 2 contacts the purge gas). As a result, air and moisture are expelled from an interior and surfaces of the submersible pump 2. In the following descriptions, a process of exposing the submersible pump 2 to the purge gas in the purge container 1 before the submersible pump 2 is put into the pump column 3 is referred to as drying-up operation.

The liquefied gas is discharged from the pump column 3 before or after the drying-up operation. Specifically, with an upper opening of the purge container 1 or an upper opening of the pump column 3 closed, purge gas is supplied into the pump column 3 through a purge-gas introduction port 8, so that the liquefied gas is discharged from the pump column 3 through the suction valve 6 by a pressure of the purge gas. In one embodiment, discharging of the liquefied gas from the pump column 3 is performed before the submersible pump 2 is located in the purge container 1. In one embodiment, discharging of the liquefied gas from the pump column 3 may be performed after the submersible pump 2 is located in the purge container 1.

After the drying-up operation for the submersible pump 2 is completed, the submersible pump 2 is lowered (moved) from the purge container 1 into the pump column 3 by the elevating device 12 until the submersible pump 2 is installed on the bottom of the pump column 3. Before or after the submersible pump 2 is installed on the bottom of the pump column 3, the upper opening of the pump column 3 is closed by a lid. When the suction valve 6 is opened, the liquefied gas in the liquefied-gas storage tank 5 flows into the pump column 3. The submersible pump 2 is operated to pump up the liquefied gas while the entire submersible pump 2 is immersed in the liquefied gas. The submersible pump 2 is a pump configured to be operable in liquid. The purge-gas introduction port 8 and a liquefied-gas discharge port 9 are provided on the upper portion of the pump column 3. The liquefied gas pumped up by the submersible pump 2 is discharged through the liquefied-gas discharge port 9.

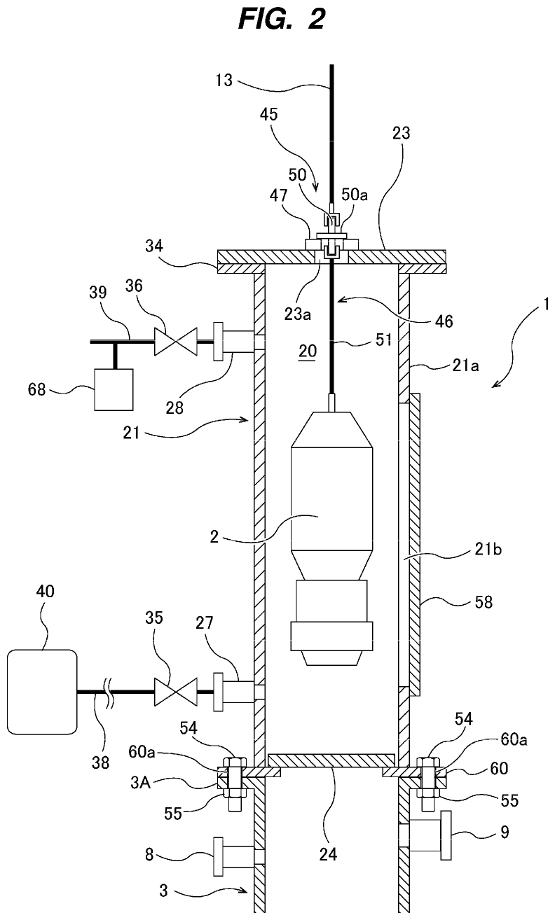

FIG. 2 is a cross-sectional view showing an embodiment of the purge container 1. The purge container 1 includes a container body 21 having the interior space 20 for accommodating the submersible pump 2 therein, an upper lid 23 configured to cover an upper opening of the container body 21, a lower lid 24 configured to cover a lower opening of the container body 21, and a purge-gas inlet port 27 and a purge-gas outlet port 28 communicating with the interior space 20 of the container body 21. The container body 21 has a hollow structure. In this embodiment, the container body 21 has a cylindrical shape, but the shape of the container body 21 is not particularly limited. In one embodiment, the container body 21 may have a polygonal hollow structure, or may have other shape.

The container body 21 has an upper flange 34 at a top of the container body 21. The upper lid 23 is placed on the upper flange 34. The purge-gas inlet port 27 and the purge-gas outlet port 28 are secured to a side wall 21a of the container body 21. More specifically, the purge-gas inlet port 27 is secured to a lower part of the side wall 21a of the container body 21, and the purge-gas outlet port 28 is secured to an upper part of the side wall 21a of the container body 21. In this embodiment, the purge-gas outlet port 28 is located higher than the purge-gas inlet port 27, while their arrangements are not limited to this embodiment. In one embodiment, the purge-gas inlet port 27 may be secured to the upper part of the side wall 21a of the container body 21, and the purge-gas outlet port 28 may be secured to the lower part of the side wall 21a of the container body 21. Alternatively, the purge-gas inlet port 27 and the purge-gas outlet port 28 may be located at the same height. Further, in one embodiment, one of the purge-gas inlet port 27 and the purge-gas outlet port 28 may be secured to the upper lid 23.

The purge container 1 further includes an inlet valve 35 coupled to the purge-gas inlet port 27, and an outlet valve 36 coupled to the purge-gas outlet port 28. A purge-gas supply line 38 is detachably coupled to the inlet valve 35. This purge-gas supply line 38 is coupled to a purge-gas supply source 40. When the purge gas is to be supplied into the purge container 1, the purge-gas supply line 38 is coupled to the inlet valve 35, and the inlet valve 35 is then opened. The purge gas is supplied from the purge-gas supply source 40 through the purge-gas supply line 38, the inlet valve 35, and the purge-gas inlet port 27 into the interior space 20 of the container body 21. While the purge gas is being supplied into the interior space 20, the outlet valve 36 is open and the air in the interior space 20 is replaced with the purge gas. A purge-gas outlet line 39 is coupled to the purge-gas outlet port 28, and the outlet valve 36 is attached to the purge-gas outlet line 39.

The purge gas used is gas composed of component (or element) having a boiling point lower than or equal to the boiling point of the liquefied gas to be pumped up by the submersible pump 2. This is because of preventing the purge gas from being liquefied when the purge gas contacts the liquefied gas or the ultra-low temperature submersible pump 2. Examples of purge gas include inert gas, such as nitrogen gas and helium gas. For example, when the liquefied gas to be pumped up by the submersible pump 2 is liquefied natural gas, nitrogen gas is used for the purge gas, since the nitrogen gas is composed of nitrogen having a boiling point (−196° C.) lower than the boiling point (−162° C.) of the liquefied natural gas. In another example, when the liquefied gas to be pumped up by the submersible pump 2 is liquid hydrogen, helium gas is used for the purge gas, since the helium gas is composed of helium having a boiling point (−269° C.) lower than the boiling point of hydrogen (−253° C.).

In one embodiment, the purge-gas supply source 40 described above is a nitrogen-gas supply source or a helium-gas supply source. Further, in one embodiment, the purge-gas supply source 40 may include purge-gas supply sources of different types, such as a nitrogen-gas supply source and a helium-gas supply source. In this case, the purge-gas supply sources may be selectively coupled to the purge-gas supply line 38.

Helium gas is generally more expensive than nitrogen gas. Nitrogen has a larger atomic weight than that of helium, and therefore has a higher drying effect. Therefore, nitrogen gas may be used as the purge gas at first, and helium gas may be used as the purge gas in a final stage. For example, nitrogen gas may be supplied into the interior space 20 of the purge container 1 to replace the air in the interior space 20 with nitrogen gas, and then helium gas may be supplied into the purge container 1 to fill the interior space 20 of the container body 21 with helium gas.

As shown in FIG. 2, the purge container 1 further includes a pump suspension mechanism 45 detachably attached to the upper lid 23. The pump suspension mechanism 45 is configured to suspend the submersible pump 2 within the interior space 20 of the container body 21. The pump suspension mechanism 45 includes a coupling member 46 coupled to the submersible pump 2, and a stopper 47 engaged with the coupling member 46. More specifically, the coupling member 46 includes a coupling link 50 and a suspension cable 51 extending downward from the coupling link 50. The coupling link 50 has a projecting portion 50a projecting laterally. The stopper 47 is engaged with the projecting portion 50a of the coupling link 50.

The upper lid 23 has a hole 23a having a shape that does not allow passage of the stopper 47. A width of the hole 23a is larger than a width of the coupling link 50, so that the coupling link 50 is allowed to pass through the hole 23a. On the other hand, the width of the hole 23a is smaller than a width of the stopper 47, so that the stopper 47 is not allowed to pass through the hole 23a. The stopper 47 is placed on the upper surface of the upper lid 23 to prevent the coupling link 50 from falling into the container body 21. As can be seen from FIG. 2, a load (or weight) of the submersible pump 2 is applied to the upper lid 23 via the pump suspension mechanism 45 including the coupling link 50 and the stopper 47. In other words, the load of the submersible pump 2 is supported by the upper lid 23.

The stopper 47 is detachably engaged with the coupling link 50. In this embodiment, the stopper 47 is a split ring (e.g., two-split ring) constituting of a plurality of (typically two) members. However, the configurations of the coupling link 50 and the stopper 47 are not limited to this embodiment. For example, the stopper 47 may be a single member (e.g., a U-shaped member) having a gap extending outwardly from a center thereof. Further, the coupling link 50 may be a shackle-like structure. In another example, the coupling link 50 may have a through-hole extending horizontally instead of having the projecting portion 50a, and the stopper 47 may be a rod member inserted into the through-hole. In this case also, the rod member does not pass through the hole 23a of the upper lid 23, and the coupling link 50 can be prevented from falling into the container body 21.

The lower lid 24 is removably placed on the bottom of the container body 21. The container body 21 has a lower flange 60 at a lower portion of the container body 21. The lower lid 24 is disposed on the lower flange 60. The lower lid 24 is a lid with no hole so that the purge gas filling the interior space 20 of the container body 21 does not leak through the lower lid 24. In one embodiment, the lower lid 24 may be constructed from a plurality of members. For example, the lower lid 24 may be a two-split lid having two members. The lower flange 60 has a plurality of through-holes 60a into which a plurality of bolts 54 are inserted, respectively. The lower lid 24 may be removably secured to the container body 21 by screws or one or more clamps. In one embodiment, a valve may be used instead of the lower lid 24.

The purge container 1 further includes a side lid 58 configured to close an opening 21b formed in the side wall 21a of the container body 21. The side lid 58 is removably secured to the side wall 21a of the container body 21 by a fastening mechanism (for example, a plurality of screws) not shown. When the side lid 58 is removed, a worker can access the lower lid 24 in the container body 21 through the opening 21b and can remove the lower lid 24 from the container body 21. Similarly, a worker can bring the lower lid 24 into the container body 21 through the opening 21b and can place the lower lid 24 on the bottom of the container body 21 (i.e., on the lower flange 60).

The lower flange 60 of the container body 21 is secured to an upper flange 3A of the pump column 3 by bolts 54 and nuts 55 as a purge-container coupling mechanism. In one embodiment, the purge-container coupling mechanism may be one or more clamps. The load (or weight) of the submersible pump 2 is supported by the upper lid 23 and further supported by the pump column 3 via the container body 21.

In one embodiment, the submersible pump 2 may be placed on the lower lid 24. In this case, the pump suspension mechanism 45 including the coupling link 50 and the stopper 47 is not used, and the lower lid 24 is configured to support the submersible pump 2. More specifically, the lower lid 24 has sufficiently high mechanical strength to support the load of the submersible pump 2.

The purge container 1 includes a purge index measuring device 68 communicating with the purge-gas outlet port 28. The purge index measuring device 68 is configured to measure an index value indicating a degree of dryness of the submersible pump 2 that has been exposed to the purge gas, and/or to measure an index value indicating a temperature of the submersible pump 2 that has been exposed to the purge gas. Examples of the purge index measuring device 68 include dew-point meter, thermometer, and a combination thereof. For example, the dew-point meter measures an amount of moisture in the purge gas that has flowed out of the interior space 20 of the container body 21. Whether or not the submersible pump 2 exposed to the purge gas has been sufficiently dried (i.e., whether or not the drying-up operation described below is sufficiently performed) can be determined based on a measured value of the amount of moisture. The thermometer measures the temperature of the purge gas that has flowed out of the interior space 20. Whether or not the submersible pump 2 exposed to the purge gas has been sufficiently warmed (i.e., whether the hot-up operation described below is sufficiently performed) can be determined based on a measured value of the temperature of the purge gas that has contacted the submersible pump 2. The amount of moisture in the purge gas and the temperature of the purge gas are examples of index values for the drying-up operation and the hot-up operation for the submersible pump 2. The index values may be other physical quantities as long as they indicate the degree of dryness and the temperature of the submersible pump 2. In FIG. 2, the purge index measuring device 68 is coupled to the outlet valve 36, but the arrangement of the purge index measuring device 68 is not limited to the embodiment shown in FIG. 2, as long as the purge index measuring device 68 can fulfill its intended function.

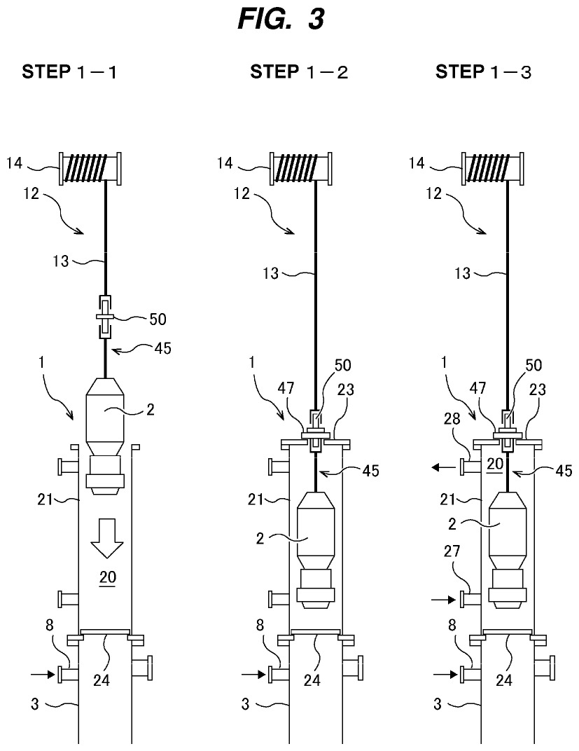

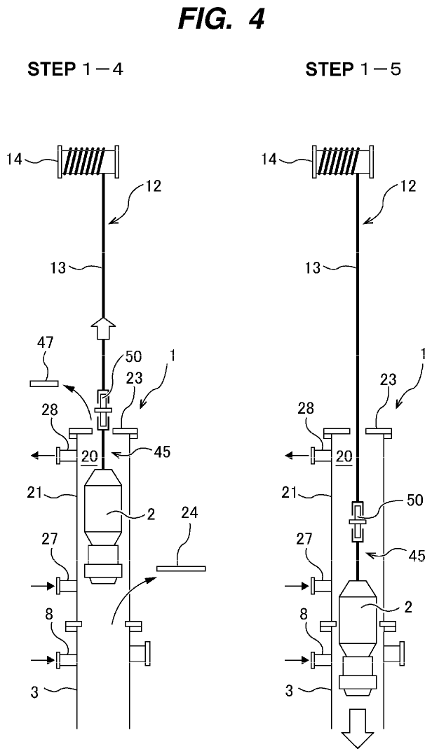

Next, an embodiment of a method of exposing the submersible pump 2 to the purge gas using the purge container 1 described above will be described with reference to FIGS. 3 and 4. A series of operations shown in FIGS. 3 and 4 includes the drying-up operation of drying the submersible pump 2 with the purge gas and an operation of carrying the dried submersible pump 2 into the pump column 3. The liquefied gas is expelled from the pump column 3 prior to operations described below.

In step 1-1, the submersible pump 2 is lowered by the elevating device 12 and placed into the interior space 20 of the container body 21 secured to the pump column 3. The lower lid 24 is placed on the bottom of the container body 21 of the purge container 1, and the upper lid 23 is not attached to the container body 21. The cable 13 of the elevating device 12 is coupled to the submersible pump 2 via the coupling link 50 of the pump suspension mechanism 45. The submersible pump 2 is suspended by the elevating device 12. In order to prevent ambient air from entering the pump column 3, purge gas (e.g., an inert gas, such as nitrogen gas or helium gas) is supplied into the pump column 3 through the purge-gas introduction port 8. The supply of purge gas into the pump column 3 is continued in the following steps.

In step 1-2, when the submersible pump 2 is placed at a predetermined position in the container body 21, the upper lid 23 is placed on the upper portion of the container body 21, and further the stopper 47 is placed on the upper lid 23. The stopper 47 is engaged with the coupling link 50. Most of the load of the submersible pump 2 is supported by the upper lid 23 via the pump suspension mechanism 45 including the coupling link 50 and stopper 47 (see FIG. 2).

In step 1-3, while the upper opening of the container body 21 is covered with the upper lid 23 and the lower opening of the container body 21 is covered with the lower lid 24, the purge gas, such as nitrogen gas or helium gas, is supplied into the interior space 20 of the container body 21 through the purge-gas inlet port 27 to fill the interior space 20 in which the submersible pump 2 is disposed. The purge gas is discharged from the interior space 20 through the purge-gas outlet port 28. The purge gas expels air and moisture out of the submersible pump 2, so that the submersible pump 2 is dried up (the drying-up operation). An end of the drying-up operation is determined based on the index value (for example, a measured value of the amount of moisture) output from the purge index measuring device 68.

In step 1-4, the coupling link 50 and the submersible pump 2 are slightly elevated by the elevating device 12 while the purge gas is supplied through the purge-gas inlet port 27 into the interior space 20 of the container body 21, and the stopper 47 is then removed. The load of the submersible pump 2 is supported by the elevating device 12. Further, the lower lid 24 is removed from the container body 21. The purge gas is exhausted from the interior space 20 of the container body 21 through the purge-gas outlet port 28. At the same time, the purge gas flows out through minute gaps other than the purge-gas outlet port 28 of the purge container 1. Such flow of the purge gas can prevent the ambient air from flowing into the container body 21.

In step 1-5, the elevating device 12 lowers the submersible pump 2 to move the submersible pump 2 from the purge container 1 into the pump column 3.

According to this embodiment, the submersible pump 2 is exposed to the purge gas in the purge container 1 secured to the upper portion of the pump column 3, immediately before the submersible pump 2 is moved into the pump column 3. Air and moisture entrained with the submersible pump 2 are removed from the submersible pump 2 by the purge gas. As a result, the submersible pump 2 is dried (deaerated). Since this drying-up operation is performed directly above the pump column 3, the submersible pump 2 can be rapidly moved into the pump column 3 with the purge gas existing around the submersible pump 2 after the drying-up operation. Therefore, the air and moisture are not entrained with the submersible pump 2, and the air and moisture are prevented from entering the pump column 3.

In one embodiment, after the submersible pump 2 is installed in the pump column 3, the purge container 1 may be separated from the pump column 3 and may be stored in a separate location.

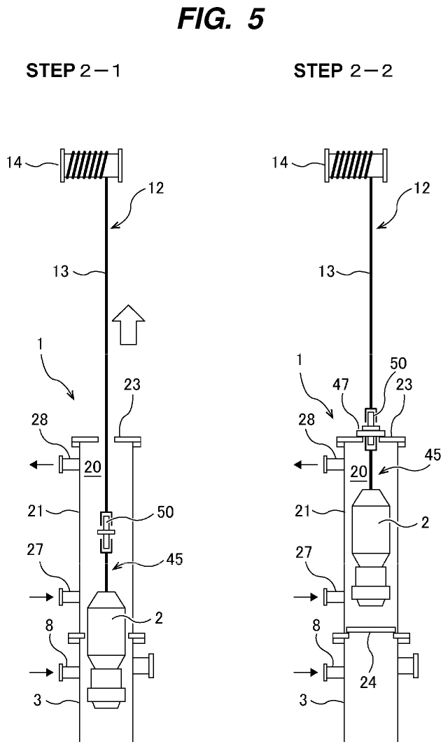

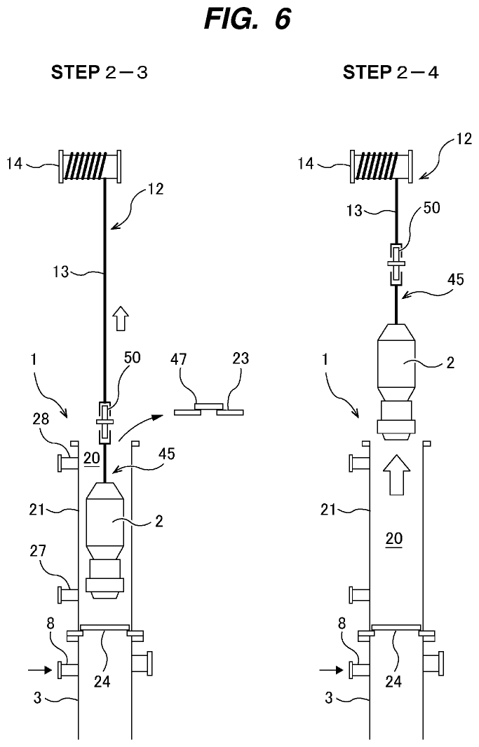

Next, an embodiment of processes of pulling up the submersible pump 2 out of the pump column 3 will be described with reference to FIGS. 5 and 6. A series of operations shown in FIGS. 5 and 6 includes an operation of pulling up the submersible pump 2 out of the pump column 3, and the hot-up operation of warming the ultra-low temperature submersible pump 2 that has been in contact with the liquefied gas with the purge gas. The liquefied gas is expelled from the pump column 3 prior to operations described below.

In step 2-1, purge gas, such as nitrogen gas or a helium gas, is supplied into the interior space 20 of the container body 21 through the purge-gas inlet port 27 to fill the interior space 20, while the submersible pump 2 is pulled out of the pump column 3 into the purge container 1 by the elevating device 12. At this stage, the lower lid 24 is not attached to the container body 21. The upper lid 23 is placed on the upper portion of the container body 21. In order to prevent the ambient air from entering the pump column 3, purge gas (e.g., an inert gas, such as nitrogen gas or helium gas) is supplied into the pump column 3 through the purge-gas introduction port 8. The supply of the purge gas into the pump column 3 is continued in the following steps.

In step 2-2, when the submersible pump 2 is placed at a predetermined position in the container body 21, the lower lid 24 is placed on the bottom of the container body 21. Specifically, the side lid 58 shown in FIG. 2 is removed from the container body 21, the lower lid 24 is carried into the container body 21 through the opening 21b (see FIG. 2), and the lower lid 24 is placed onto the bottom of the container body 21 (i.e., onto the lower flange 60). Further, the stopper 47 is placed onto the upper lid 23 and engaged with the coupling link 50. Most of the load of the submersible pump 2 is supported by the upper lid 23 via the pump suspension mechanism 45 including the coupling link 50 and the stopper 47.

With the upper opening of the container body 21 covered with the upper lid 23 and the lower opening of the container body 21 covered with the lower lid 24, the supply of the purge gas into the interior space 20 of the container body 21 through the purge-gas inlet port 27 is continued. The purge gas is discharged from the interior space 20 through the purge-gas outlet port 28. The purge gas to be supplied into the interior space 20 may have an ordinary temperature, or may be preheated by a heating device, such as a heater. The purge gas filling the interior space 20 of the container body 21 warms the submersible pump 2 (the hot-up operation). An end of the hot-up operation is determined based on the index value (for example, the measured value of the temperature of the purge gas) output from the purge index measuring device 68. Specifically, whether or not the submersible pump 2 exposed to the purge gas has been sufficiently warmed (i.e., whether or not the hot-up operation is sufficiently performed) is determined based on the measured value of the temperature of the purge gas that has contacted the submersible pump 2.

In step 2-3, the supply of the purge gas into the interior space 20 of the container body 21 is stopped. The coupling link 50 and the submersible pump 2 are slightly elevated by the elevating device 12, and the stopper 47 and the upper lid 23 are then removed. The load of the submersible pump 2 is supported by the elevating device 12.

In step 2-4, the submersible pump 2 is further elevated by the elevating device 12 until the submersible pump 2 is removed from the purge container 1. At this point, the submersible pump 2 has been already warmed by the purge gas and has a temperature higher than the boiling point of oxygen (−183° C.). Therefore, even when the air comes into contact with the submersible pump 2, the oxygen and nitrogen in the air are not liquefied.

According to this embodiment, the ultra-low temperature submersible pump 2 can be warmed with the purge gas while being pulled up from the pump column 3 into the purge container 1 (the hot-up operation). This hot-up operation is performed before the submersible pump 2 contacts the ambient air, so that moisture in the air is not liquefied or solidified on the surfaces of the submersible pump 2. In particular, the present invention is effective when the liquefied gas is liquid hydrogen. Specifically, the submersible pump 2 that has been immersed in liquid hydrogen has an ultra-low temperature equivalent to that of liquid hydrogen when the submersible pump 2 is pulled out of the pump column 3. The boiling point of hydrogen (−253° C.) is lower than the boiling point of oxygen (−183° C.) and the boiling point of nitrogen (−196° C.). Therefore, when the air comes into contact with the submersible pump 2 immediately after the submersible pump 2 is pulled out of the pump column 3, not only nitrogen but also oxygen in the air is liquefied and may drop into the pump column 3. In this regard, according to the present embodiment, the submersible pump 2 that has been immersed in liquid hydrogen is rapidly warmed by the purge gas before the submersible pump 2 contacts the air. Therefore, when the air comes into contact with the submersible pump 2, the oxygen and nitrogen in the air are not liquefied, and thus the liquefied oxygen and liquefied nitrogen do not drop into the pump column 3. As a result, safe removal of the submersible pump 2 can be achieved.

In one embodiment, after the submersible pump 2 is removed from the purge container 1, the purge container 1 may be separated from the pump column 3 and may be stored in a separate location. In this embodiment, as shown in the step 2-4 of FIG. 6, the submersible pump 2 is pulled up and removed from the purge container 1 by the elevating device 12. In one embodiment, the submersible pump 2 may be removed from the purge container 1 through the opening 21b (see FIG. 2), which is formed in the side wall 21a of the container body 21, by a hoisting device (e.g., crane) not shown.

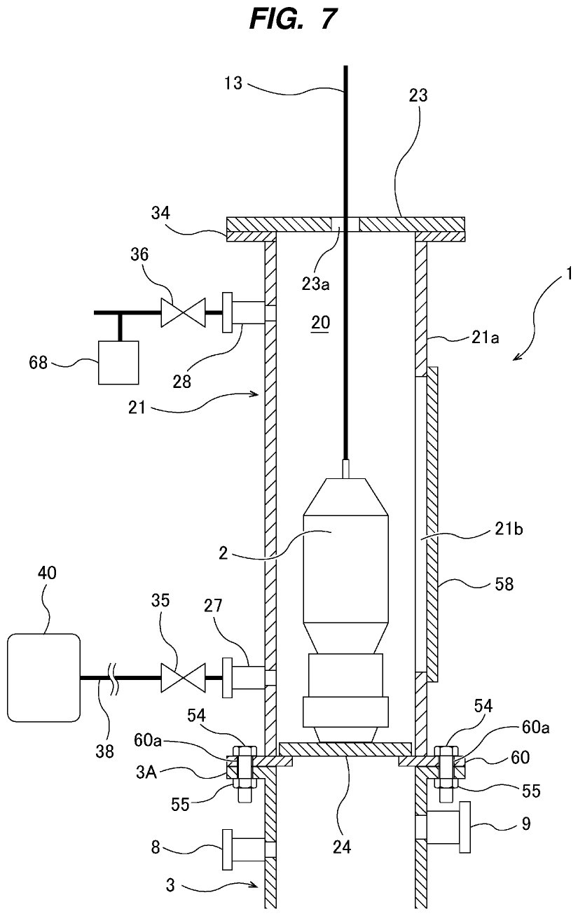

Next, another embodiment of the purge container 1 will be described. FIG. 7 is a cross-sectional view showing another embodiment of the purge container 1. Configurations of this embodiment, which will not be particularly described, are the same as those of the embodiment described with reference to FIG. 2, and redundant descriptions thereof will be omitted.

As shown in FIG. 7, the submersible pump 2 is supported by the lower lid 24 of the purge container 1. Specifically, the submersible pump 2 is placed on the lower lid 24 without the pump suspension mechanism 45 shown in FIG. 2. Therefore, the load of the submersible pump 2 is supported by the lower lid 24. The lower lid 24 is configured to be able to support the submersible pump 2. More specifically, the lower lid 24 has sufficiently high mechanical strength to support the load of the submersible pump 2.

The center of the upper lid 23 has the hole 23a through which the cable 13 of the elevating device 12 can pass. In this embodiment, the hole 23a is composed of a gap extending outwardly from its center.

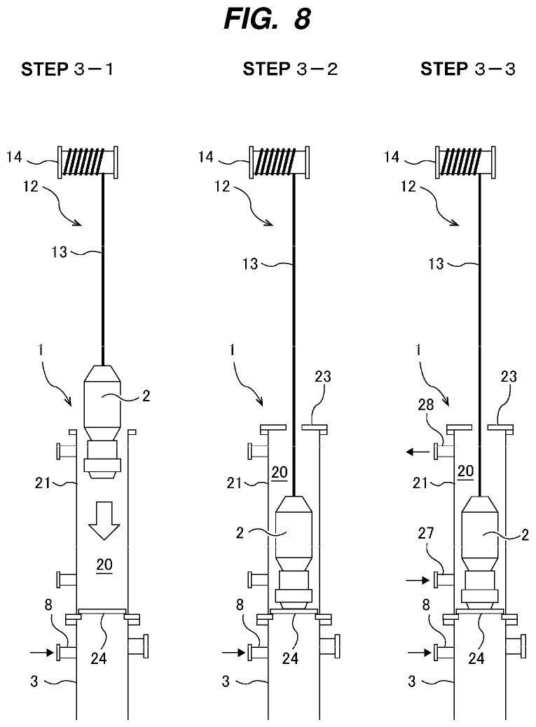

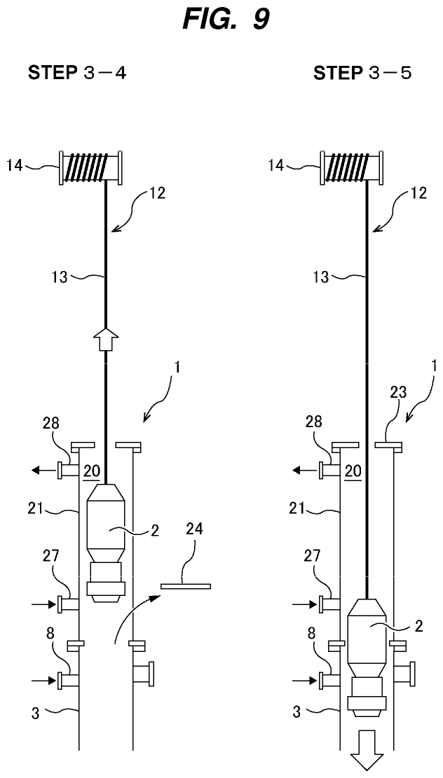

Next, an embodiment of a method of exposing the submersible pump 2 to the purge gas using the purge container shown in FIG. 7 will be described with reference to FIGS. 8 and 9. A series of operations shown in FIGS. 8 and 9 includes the drying-up operation of drying the submersible pump 2 with the purge gas and an operation of carrying the dried submersible pump 2 into the pump column 3. The liquefied gas is expelled from the pump column 3 prior to operations described below.

In step 3-1, the submersible pump 2 is lowered by the elevating device 12, and placed in the interior space 20 of the container body 21 secured to the pump column 3. The lower lid 24 is placed onto the bottom of the container body 21 of the purge container 1, and the upper lid 23 is not attached to the container body 21. In order to prevent the ambient air from entering the pump column 3, purge gas (e.g., an inert gas, such as nitrogen gas or helium gas) is supplied into the pump column 3 through the purge-gas introduction port 8. The supply of the purge gas into the pump column 3 is continued in the following steps.

In step 3-2, the submersible pump 2 is placed on the lower lid 24 by the elevating device 12. Most of the load of the submersible pump 2 is supported by the lower lid 24. Further, the upper lid 23 is placed on the upper portion of the container body 21.

In step 3-3, with the upper opening of the container body 21 covered with the upper lid 23 and the lower opening of the container body 21 covered with the lower lid 24, the purge gas, such as nitrogen gas or helium gas, is supplied into the interior space 20 of the container body 21 through the purge-gas inlet port 27 to fill the interior space 20 in which the submerge pump 2 is disposed. The purge gas is discharged from the interior space 20 through the purge-gas outlet port 28. The purge gas expels air and moisture out of the submersible pump 2, so that the submersible pump 2 is dried up (the drying-up operation). An end of the drying-up operation is determined based on the index value (for example, a measured value of the amount of moisture) output from the purge index measuring device 68.

The purge gas is exhausted from the interior space 20 of the container body 21 through the purge-gas outlet port 28, and at the same time, the purge gas flows out through minute gaps other than the purge-gas outlet port 28 of the purge container 1. Such flow of the purge gas can prevent the ambient air from flowing into the container body 21.

In step 3-4, the submersible pump 2 is slightly elevated by the elevating device 12 while the purge gas is supplied through the purge-gas inlet port 27 into the interior space 20 of the container body 21, and then the lower lid 24 is removed from the container body 21. The load of the submersible pump 2 is supported by the elevating device 12.

In step 3-5, the submersible pump 2 is lowered by the elevating device 12, so that the submersible pump 2 is moved from the purge container 1 into the pump column 3.

In one embodiment, after the submersible pump 2 is installed in the pump column 3, the purge container 1 may be separated from the pump column 3 and may be stored in a separate location.

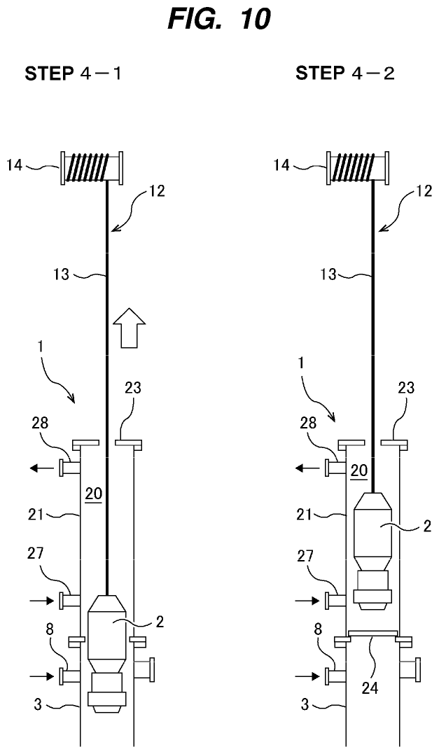

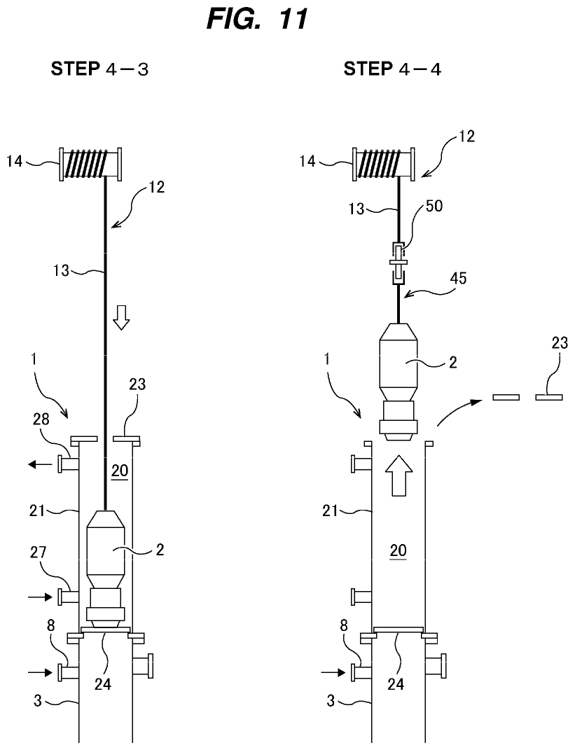

Next, an embodiment of processes of pulling up the submersible pump 2 out of the pump column 3 will be described with reference to FIGS. 10 and 11. A series of operations shown in FIGS. 10 and 11 includes an operation of pulling up the submersible pump 2 out of the pump column 3, and the hot-up operation of warming the ultra-low temperature submersible pump 2 that has been in contact with the liquefied gas with the purge gas. The liquefied gas is expelled from the pump column 3 prior to operations described below.

In step 4-1, purge gas, such as nitrogen gas or helium gas, is supplied into the interior space 20 of the container body 21 through the purge-gas inlet port 27 to fill the interior space 20, while the submersible pump 2 is pulled up from the pump column 3 into the container body 21 by the elevating device 12. At this stage, the lower lid 24 is not attached to the container body 21. The upper lid 23 is placed on the upper portion of the container body 21. The upper lid 23 is placed on the upper portion of the container body 21. In order to prevent the ambient air from entering the pump column 3, purge gas (e.g., an inert gas, such as nitrogen gas or helium gas) is supplied into the pump column 3 through the purge-gas introduction port 8. The supply of the purge gas into the pump column 3 is continued in the following steps.

In step 4-2, when the submersible pump 2 is placed at a predetermined position in the container body 21, the lower lid 24 is placed on the bottom of the container body 21.

Specifically, the side lid 58 shown in FIG. 2 is removed from the container body 21, the lower lid 24 is carried into the container body 21 through the opening 21b (see FIG. 2), and the lower lid 24 is placed onto the bottom of the container body 21 (i.e., onto the lower flange 60).

In step 4-3, the submersible pump 2 is placed on the lower lid 24 by the elevating device 12. Most of the load of the submersible pump 2 is supported by the lower lid 24. With the upper opening of the container body 21 covered with the upper lid 23 and the lower opening of the container body 21 covered with the lower lid 24, the supply of the purge gas into the interior space 20 of the container body 21 through the purge-gas inlet port 27 is continued. The purge gas is discharged from the interior space 20 through the purge-gas outlet port 28. The purge gas to be supplied into the interior space 20 may have an ordinary temperature, or may be preheated by a heating device, such as a heater. The purge gas filling the interior space 20 of the container body 21 warms the submersible pump 2 (the hot-up operation). An end of the hot-up operation is determined based on the index value (for example, the measured value of the temperature of the purge gas) output from the purge index measuring device 68.

In step 4-4, the supply of the purge gas into the interior space 20 of the container body 21 is stopped, and the upper lid 23 is removed. The submersible pump 2 is then pulled up by the elevating device 12 until the submersible pump 2 is removed out of the purge container 1. At this point, the submersible pump 2 has been already warmed by the purge gas, and has a temperature higher than the boiling point of oxygen (−183° C.) and the boiling point of nitrogen (−196° C.). Therefore, even when the air comes into contact with the submersible pump 2, the oxygen and nitrogen in the air are not liquefied.

In one embodiment, after the submersible pump 2 is removed from the purge container 1, the purge container 1 may be separated from the pump column 3 and may be stored in a separate location. In this embodiment, as shown in the step 4-4 of FIG. 11, the submersible pump 2 is elevated out of the purge container 1 by the elevating device 12. In one embodiment, the submersible pump 2 may be removed from the purge container 1 through the opening 21b (see FIG. 7), which is formed in the side wall 21a of the container body 21, by a hoisting device (e.g., crane) not shown.

As described above, the lower lid 24 is attached and removed while the purge gas is supplied into the pump column 3 and the purge container 1, so that the ambient air is prevented from entering the purge container 1. As a result, the submersible pump 2 can be safely carried in and out of the liquefied-gas storage tank 5 via the purge container 1 provided on the upper portion of the pump column 3.

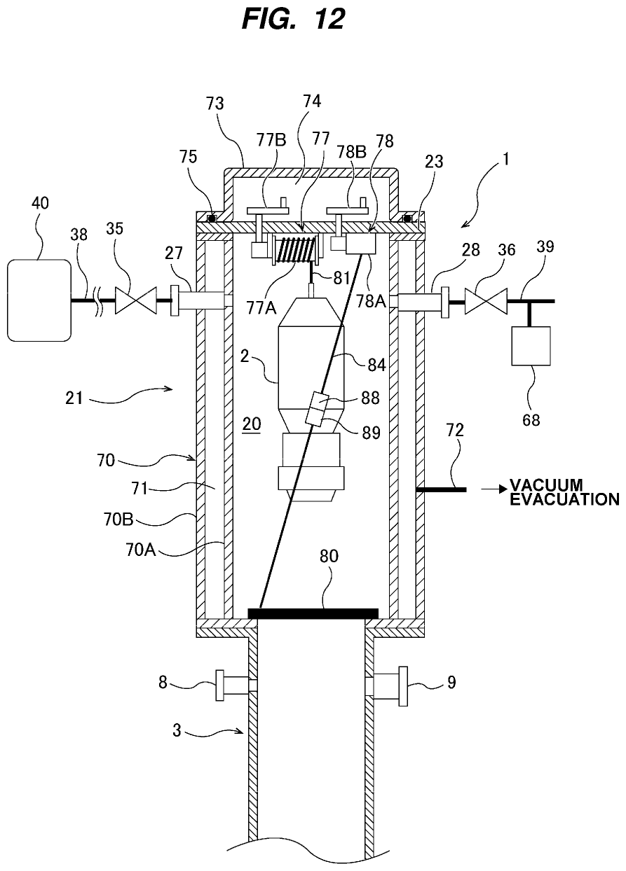

Next, still another embodiment of the purge container 1 will be described. FIG. 12 is a cross-sectional view showing still another embodiment of the purge container 1. Configurations of this embodiment, which will not be particularly described, are the same as those of the embodiment described with reference to FIG. 2, and redundant descriptions thereof will be omitted. The purge container 1 according to this embodiment does not have the lower lid 24 and the side lid 58 described with reference to FIG. 2. Furthermore, the container body 21 of the purge container 1 does not have the opening 21b described with reference to FIG. 2.

As shown in FIG. 12, the container body 21 of the purge container 1 has a side wall 70 having a double-walled structure serving as a heat-insulating structure. The side wall 70 with the double-walled structure includes an inner wall 70A and an outer wall 70B. A space 71 is formed between the inner wall 70A and the outer wall 70B. This space 71 communicates with a vacuum line 72, and the space 71 is evacuated by a vacuum source (e.g., a vacuum pump) not shown. The sidewall 70 having such double-walled structure can easily block heat, thus significantly reducing a transfer of heat from the outside to the interior space 20 of the purge container 1. In one embodiment, the sidewall 70 may have, instead of the double-walled structure shown in FIG. 12, a heat insulating structure, such as vacuum insulation with urethane foam, or perlite.

The purge-gas inlet port 27 and the purge-gas outlet port 28 extend through the space 71 formed between the inner wall 70A and the outer wall 70B, and communicate with the interior space 20 of the container body 21 of the purge container 1. The purge container 1 includes the upper lid 23 configured to cover the upper opening of the container body 21, a sealing cover 73 configured to cover the upper surface of the upper lid 23, an inner elevating device 77 attached to a lower surface of the upper lid 23, and a door opening-closing device 78 attached to the lower surface of the upper lid 23, and a door structure 80 serving as a lower lid configured to cover the lower opening of the container body 21.

The sealing cover 73 is removably attached to the upper lid 23 by fasteners (such as screws, or clamps) not shown. The sealed cover 73 has a shape protruding upward, and a space 74 is formed between the sealing cover 73 and the upper lid 23. The sealing cover 73 has a sealing member (e.g., O-ring) 75 at a portion that contacts the upper lid 23. The sealing member 75 is arranged so as to surround the space 74, and the space 74 is hermetically sealed by the sealing member 75.

The door structure 80 is pivotably coupled to the bottom of the container body 21 by use of a hinge which is not shown. The bottom of the container body 21 of the purge container 1 is secured to the upper portion of the pump column 3. The door structure 80 in this embodiment is a single swing door. In one embodiment the door structure 80 may be a double swing door.

The inner elevating device 77 is coupled to the submersible pump 2 through a suspension cable 81 and is configured to elevate and lower the submersible pump 2 within the purge container 1 and the pump column 3. The inner elevating device 77 has a pump hoisting device 77A arranged in the interior space 20 of the purge container 1, and an elevation handle 77B arranged outside the upper lid 23. The elevation handle 77B is coupled to the pump hoisting device 77A. The elevation handle 77B is located outside the interior space 20 of the purge container 1. More specifically, the elevation handle 77B is located within the enclosed space 74 formed between the sealing cover 73 and the upper lid 23. When the sealing cover 73 is removed from the upper lid 23, a worker can access the elevation handle 77B, and can operate the elevation handle 77B.

A worker can operate the elevation handle 77B outside the purge container 1 to actuate the pump hoisting device 77A, thereby elevating and lowering the submersible pump 2 in the purge container 1 and pump column 3. Examples of the inner elevating device 77 include a winch and a hoist. The inner elevating device 77 in this embodiment is a manual-type elevating device. In one embodiment, the inner elevating device 77 may be an actuator-driven elevating device, such as an electric elevating device.

The door structure 80 is coupled to the door opening-closing device 78 through a door cable 84. The door opening-closing device 78 has a door drive mechanism 78A arranged in the interior space 20 of the purge container 1, and an opening-closing handle 78B arranged outside the upper lid 23. The opening-closing handle 78B is coupled to the door drive mechanism 78A. The opening-closing handle 78B is located outside the interior space 20 of the purge container 1. More specifically, the opening-closing handle 78B is located within the enclosed space 74 formed between the sealing cover 73 and the upper lid 23. When the sealing cover 73 is removed from the upper lid 23, a worker can access the opening-closing handle 78B, and can operate the opening-closing handle 78B. The door drive mechanism 78A is coupled to the door structure 80 through the door cable 84. In one embodiment, the door drive mechanism 78A may be coupled to the door structure 80 through a combination of gears (e.g., a rack-and-pinion), instead of the door cable 84.

A worker can operate the door opening-closing handle 78B outside the purge container 1 to actuate the door drive mechanism 78A, thereby opening and closing the door structure 80. Examples of door opening-closing device 78 include a winch and a hoist. The door opening-closing device 78 in this embodiment is a manual-type opening-closing device. In one embodiment, the door opening-closing device 78 may be an actuator-driven opening-closing device, such as an electric opening-closing device.

A first engagement member 88 and a second engagement member 89 (e.g., hooks) are attached to the door cable 84. These engagement members 88, 89 can be engaged with and disengaged from each other. Therefore, the door cable 84 can be divided into a segment coupled to the first engagement member 88 and the door opening-closing device 78, and a segment coupled to the second engagement member 89 and the door structure 80. When the first engagement member 88 is engaged with the second engagement member 89, the two segments of the door cable 84 are coupled to each other.

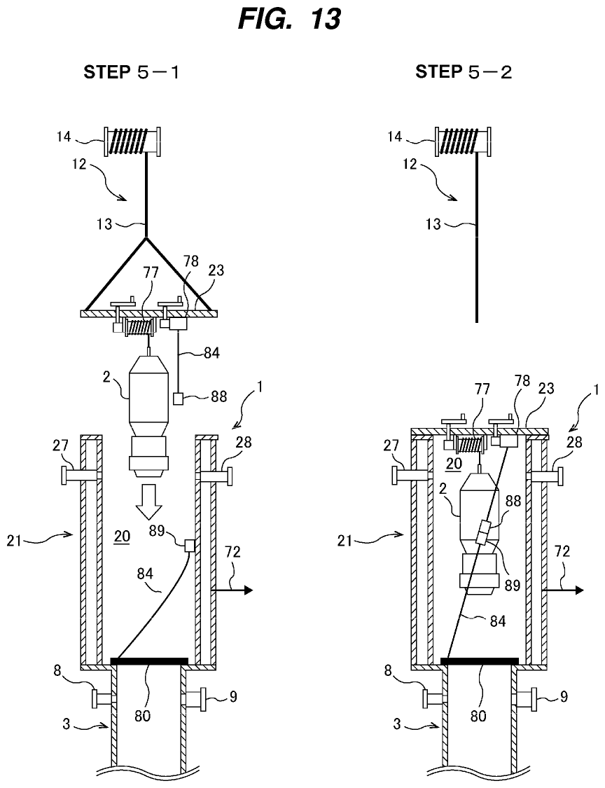

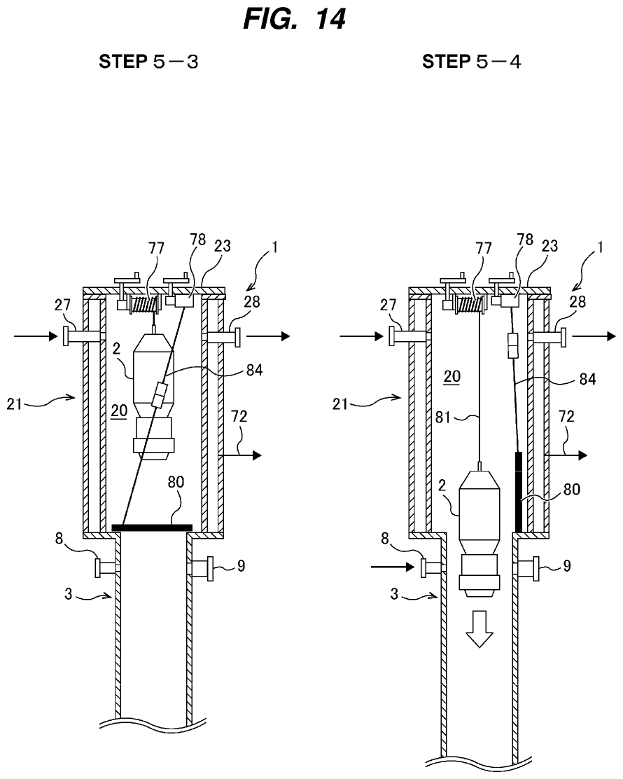

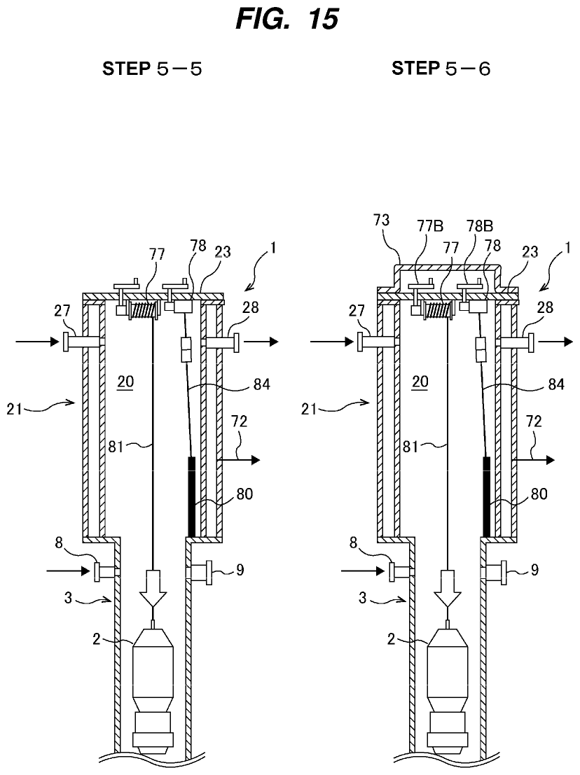

Next, an embodiment of a method of exposing the submersible pump 2 to the purge gas using the purge container 1 described above will be described with reference to FIGS. 13 to 15. A series of operations shown in FIGS. 13 to 15 includes the drying-up operation of drying the submersible pump 2 with the purge gas and an operation of carrying the dried submersible pump 2 into the pump column 3. The liquefied gas is expelled from the pump column 3 prior to operations described below.

In step 5-1, with the sealing cover 73 removed from the upper lid 23, the elevating device 12 lowers the upper lid 23, the inner elevating device 77, the door opening-closing device 78, and the submersible pump 2, so that the submersible pump 2 is placed in the interior space 20 of the container body 21 of the purge container 1. The door structure 80 has been closed, and the second engagement member 89 is temporarily held by a holding member (not shown), such as a hook, which is provided on an inner surface of the container body 21. The first engagement member 88 is hung from the door opening-closing device 78.

In step 5-2, the first engagement member 88 is engaged with the second engagement member 89 by a worker, and then the submersible pump 2 is placed at a predetermined position in the purge container 1. The upper lid 23 closes the upper opening of the container body 21 of the purge container 1. The suspension cable 13 of the elevating device 12 is separated from the upper lid 23.

In step 5-3, with the upper opening of the container body 21 covered with the upper lid 23 and the lower opening of the container body 21 covered with the door structure 80, purge gas, such as nitrogen gas or helium gas, is supplied into the interior space 20 of the purge container 1, in which the submersible pump 2 is disposed, through the purge-gas inlet port 27 to fill the internal space 20. The purge gas is discharged from the interior space 20 through the purge-gas outlet port 28. The purge gas expels air and moisture out of the submersible pump 2, so that the submersible pump 2 is dried (dry-up operation). An end of the dry-up operation is determined based on the index value (e.g., a measured value of the amount of moisture) output from the purge index measuring device 68 (see FIG. 12).

In step 5-4, the door structure 80 is opened by the door opening-closing device 78 while the purge gas is supplied through the purge-gas inlet port 27 into the interior space 20 of the purge container 1 and while the purge gas is supplied into the pump column 3 through the purge-gas introduction port 8. Further, the inner elevating device 77 lowers the submersible pump 2, thereby moving the submersible pump 2 from the purge container 1 into the pump column 3.

In step 5-5, the inner elevating device 77 further lowers the submersible pump 2 within the pump column 3.

In step 5-6, the sealing cover 73 is attached to the upper lid 23 by use of the fasteners (not shown). The sealing cover 73 covers the upper surface of the upper lid 23, the elevation handle 77B, and the opening-closing handle 78B to prevent gas leakage from the interior space 20 of the purge container 1.

According to this embodiment, the door opening-closing device 78 can open and close the door structure 80 while the interior space 20 of the purge container 1 is sealed, thereby preventing the ambient air from entering the purge container 1. Furthermore, the pump hoisting device 77A of the inner elevating device 77 is arranged inside the purge container 1, so that the suspension cable 81 does not penetrate the purge container 1. Accordingly, the ambient air can be prevented from entering the purge container 1. As a result, the amount of purge gas to be used can be decreased.

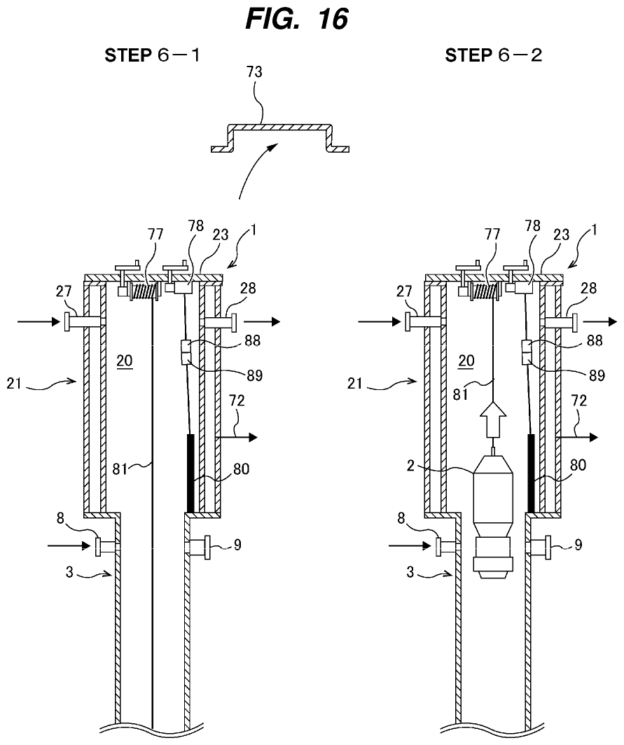

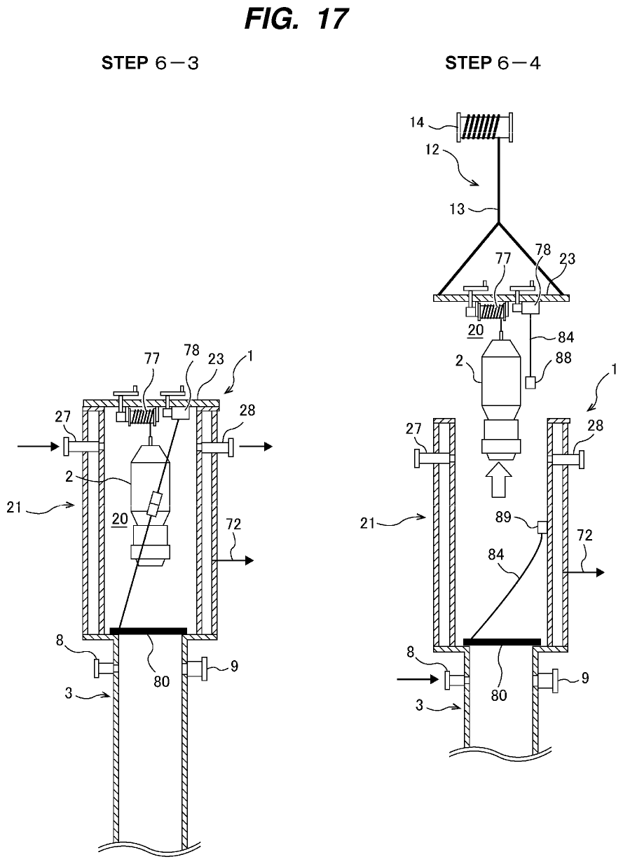

Next, an embodiment of processes of pulling up the submersible pump 2 out of the pump column 3 will be described with reference to FIGS. 16 and 17. A series of operations shown in FIGS. 16 and 17 includes an operation of pulling up the submersible pump 2 out of the pump column 3, and the hot-up operation of warming the ultra-low temperature submersible pump 2 that has been in contact with the liquefied gas with the purge gas. The liquefied gas is expelled from the pump column 3 prior to operations described below.

In step 6-1, the sealing cover 73 is removed from the upper lid 23 while purge gas, such as nitrogen gas or helium gas, is supplied through the purge-gas inlet port 27 into the interior space 20 of the purge container 1 and while purge gas is supplied through the purge-gas introduction port 8 into the pump column 3.

In step 6-2, the inner elevating device 77 elevates the submersible pump 2 in the pump column 3, and further pulls up the submersible pump 2 out of the pump column 3 into the purge container 1.

In step 6-3, when the submersible pump 2 is located in a predetermined position in the purge container 1, the opening-closing device closes the door structure 80. With the upper opening of the purge container 1 covered with the upper lid 23 and the lower opening of the purge container 1 covered with the door structure 80, the supply of the purge gas through the purge-gas inlet port 27 into the interior space 20 of the container body 21 of the purge container 1 is continued. The purge gas is discharged from the interior space 20 through the purge-gas outlet port 28. The purge gas to be supplied into the interior space 20 may have an ordinary temperature, or may be preheated by a heating device, such as a heater. The purge gas filling the interior space 20 of the container body 21 warms the submersible pump 2 (the hot-up operation). An end of the hot-up operation is determined based on the index value (for example, the measured value of the temperature of the purge gas) output from the purge index measuring device 68 (FIG. 12). Specifically, whether or not the submersible pump 2 exposed to the purge gas has been sufficiently heated (i.e., whether or not the hot-up operation is sufficiently performed) is determined from the measured value of the temperature of the purge gas that has contacted the submersible pump 2.

In step 6-4, the supply of purge gas into the interior space 20 of the purge container 1 is stopped. The first engagement member 88 is separated from the second engagement member 89. The second engagement member 89 is held by the holding member (not shown), such as a hook, which is provided on the inner surface of the container body 21. The door structure 80 is kept closed. The elevating device 12 then pulls up the upper lid 23, together with the submersible pump 2, the inner elevating device 77, and the door opening-closing device 78, from the purge container 1. At this point, the submersible pump 2 has been already warmed by the purge gas and has a temperature higher than the boiling point of oxygen (−183° C.). Therefore, even when the air comes into contact with the submersible pump 2, the oxygen and nitrogen in the air are not liquefied.

As described above, the door structure 80 can be opened and closed while the interior space 20 of the purge container 1 is sealed. Therefore, the ambient air is prevented from entering the purge container 1. As a result, the submersible pump 2 can be safely carried in and out of the liquefied-gas storage tank 5 via the purge container 1 provided on the upper portion of the pump column 3.

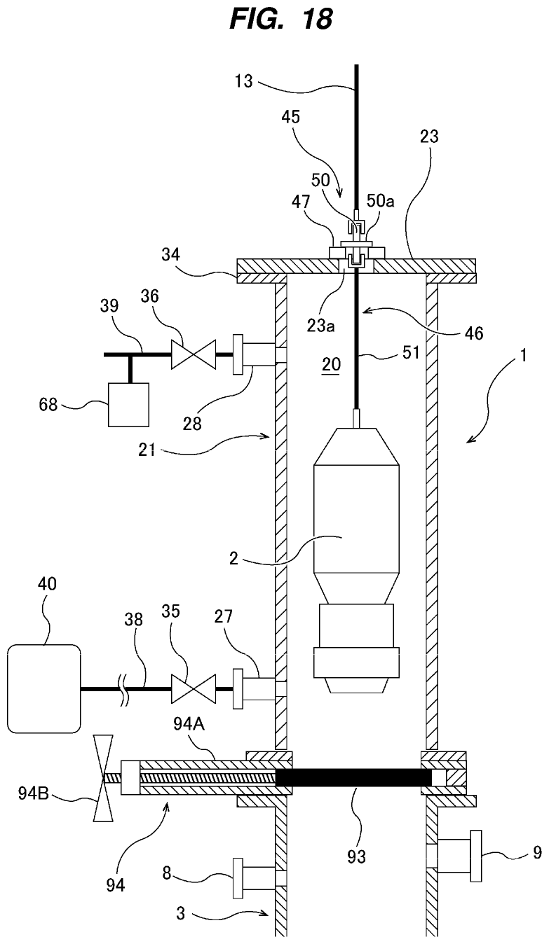

Next, still another embodiment of the purge container 1 will be described. FIG. 18 is a cross-sectional view showing still another embodiment of the purge container 1. Configurations of this embodiment, which will not be particularly described, are the same as those of the embodiment described with reference to FIG. 2, and redundant descriptions thereof will be omitted.

The purge container 1 has a gate valve 93 arranged at a lower portion thereof, and a gate-valve opening-closing device 94 coupled to the gate valve 93. The gate valve 93 serves as a lower lid that covers the lower opening of the container body 21. The lower lid 24 and the side lid 58 described with reference to FIG. 2 are not provided. Further, the side wall 21a of the container body 21 of the purge container 1 does not have the opening 21b described with reference to FIG. 2.

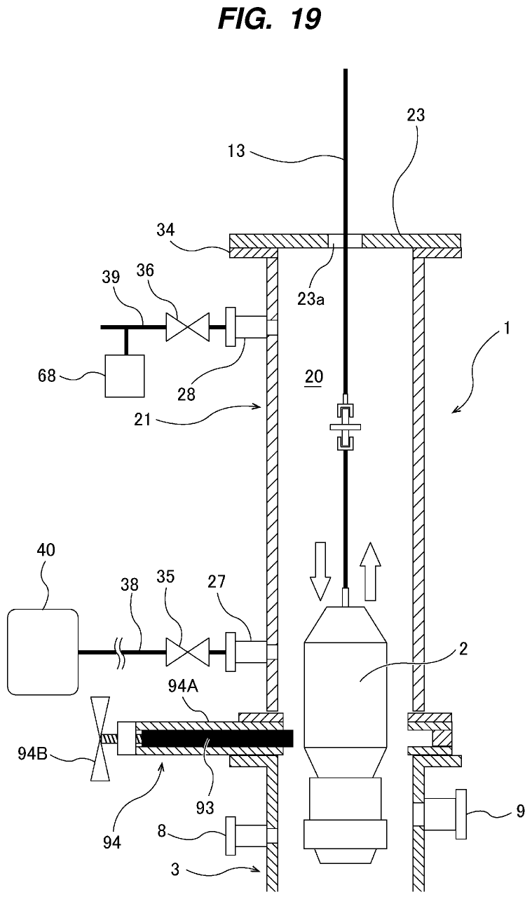

The gate valve 93 is movable in a direction perpendicular to a longitudinal direction of the purge container 1 and the pump column 3. The gate valve 93 is arranged between the container body 21 of the purge container 1 and an upper end of the pump column 3, and is configured to close the lower opening of the container body 21. Specifically, when the gate valve 93 closes the lower opening of the container body 21, the fluid communication between the interior space 20 of the purge container 1 and an interior space of the pump column 3 is cut off. As shown in FIG. 19, when the gate valve 93 is opened, the submersible pump 2 can be moved between the interior space 20 of the purge container 1 and the interior space of the pump column 3.

The gate-valve opening-closing device 94 is arranged outside the interior space 20 of the purge container 1. The gate-valve opening-closing device 94 includes a screw driving mechanism 94A having a screw shaft, and an opening-closing handle 94B for rotating the screw shaft. The gate valve 93 is coupled to the screw driving mechanism 94A, and the opening-closing handle 94B is also coupled to the screw driving mechanism 94A. When a worker rotates the opening-closing handle 94B in one direction, the gate valve 93 can be opened. When the worker rotates the opening-closing handle 94B in the opposite direction, the gate valve 93 can be closed.

The opening-closing handle 94B is arranged outside the container body 21 of the purge container 1. Therefore, the worker can open and close the gate valve 93 from outside the container body 21 (i.e., from outside the purge container 1). The gate-valve opening-closing device 94 in this embodiment is a manual gate-valve opening-closing device. In one embodiment, the gate-valve opening-closing device 94 may be an actuator-driven gate-valve opening-closing device, such as an electric gate-valve opening-closing device.

A method of exposing the submersible pump 2 to the purge gas and carrying the submersible pump 2 into the pump column 3 using the purge container 1 according to the embodiment described with reference to FIGS. 18 and 19 is the same as the embodiments described with reference to FIGS. 2 to 4, except for opening the gate valve 93, instead of removing the lower lid 24. Therefore, repetitive descriptions thereof are omitted.

Furthermore, a method of pulling up the submersible pump 2 out of the pump column 3 and exposing the submersible pump 2 to the purge gas using the purge container 1 according to the embodiment described with reference to FIGS. 18 and 19 is the same as the embodiments described with reference to FIGS. 5 to 6, except for closing the gate valve 93, instead of attaching the lower lid 24. Therefore, repetitive descriptions thereof are omitted.

The gate-valve opening-closing device 94 can open and close the gate valve 93 while the interior space 20 of the purge container 1 is kept in a sealed condition, thus preventing the ambient air from entering the purge container 1. As a result, the ambient air can be prevented from entering the purge container 1, and the submersible pump 2 can be safely carried in and out of the liquefied-gas storage tank 5 via the purge container 1 provided on the upper portion of the pump column 3.

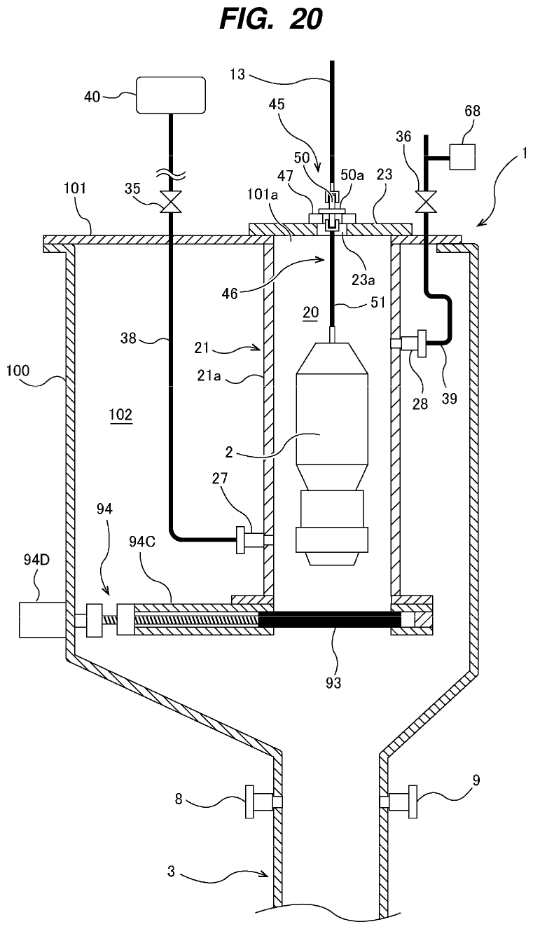

Next, still another embodiment of the purge container 1 will be described. FIG. 20 is a cross-sectional view showing still another embodiment of the purge container 1. Configurations of this embodiment, which will not be particularly described, are the same as those of the embodiment described with reference to FIG. 18, and redundant descriptions thereof will be omitted.

The pump column 3 further includes an outer shell 100 and a column lid 101 that closes an upper opening of the outer shell 100. The outer shell 100 serves as the upper portion of the pump column 3. The outer shell 100 is located above the purge-gas introduction port 8 and the liquefied-gas discharge port 9 which are provided on a portion of the pump column 3 protruding upward from the liquefied gas storage tank 5. The purge container 1 is arranged inside the outer shell 100. Specifically, an opening width of the outer shell 100 is larger than a width of an outer circumference of the container body 21 of the purge container 1. The entire container body 21 of the purge container 1 and the gate valve 93 are arranged inside the outer shell 100. The purge container 1 is secured to the column lid 101. More specifically, the upper portion of the container body 21 of the purge container 1 is secured to the column lid 101, and the container body 21 is suspended from the column lid 101 into the outer shell 100.

An upper end of the purge container 1 is exposed from the column lid 101. More specifically, the column lid 101 has a through-hole 101a which communicates with the container body 21 of the purge container 1, and the upper lid 23 of the purge container 1 is disposed so as to close the through-hole 101a. An opening width of the through-hole 101a is larger than a width of the submersible pump 2, allowing the submersible pump 2 to move through the through-hole 101a into the interior space 20 of the purge container 1.

A space 102 is formed between the side wall 21a of the container body 21 of the purge container 1 and the outer shell 100. The purge-gas supply line 38 coupled to the purge-gas inlet port 27 and the purge-gas outlet line 39 coupled to the purge-gas outlet port 28 pass through the space 102 formed by the outer shell 100, the purge container 1, and the column lid 100. The purge-gas supply line 38 and the purge-gas outlet line 39 extend from any points on the outer shell 100 or the column lid 101 to outside the space 102.

The gate-valve opening-closing device 94 is arranged outside the inner space 20 of the purge container 1. The gate-valve opening-closing device 94 includes a screw drive mechanism 94C having a screw shaft, and an opening-closing motor 94D for rotating the screw shaft. The gate valve 93 is coupled to the screw drive mechanism 94C, and the opening-closing motor 94D is also coupled to the screw drive mechanism 94C. When the opening-closing motor 94D rotates in one direction, the gate valve 93 is opened. When the opening-closing motor 94D rotates in the opposite direction, the gate valve 93 is closed. The opening-closing motor 94D is arranged outside of the outer shell 100 of the pump column 3.

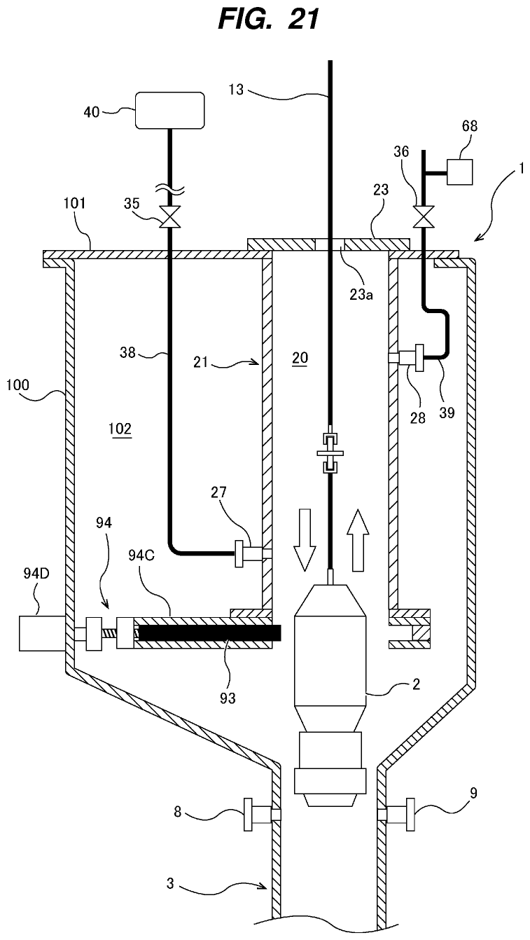

As shown in FIG. 21, when the gate valve 93 is opened, the submersible pump 2 can be moved between the interior space 20 of the purge container 1 and the interior space of the pump column 3. The gate-valve opening-closing device 94 in this embodiment is an actuator-driven gate-valve opening-closing device. In one embodiment, the gate-valve opening-closing device 94 may be a manual gate-valve opening-closing device.

A method of exposing the submersible pump 2 to the purge gas and carrying the submersible pump 2 into the pump column 3 using the purge container 1 according to the embodiment described with reference to FIGS. 20 and 21 is the same as the embodiments described with reference to FIGS. 2 to 4, except for opening the gate valve 93, instead of removing the lower lid 24. Therefore, repetitive descriptions thereof are omitted.

Furthermore, a method of pulling up the submersible pump 2 out of the pump column 3 and exposing the submersible pump 2 to the purge gas using the purge container 1 according to the embodiment described with reference to FIGS. 20 and 21 is the same as the embodiments described with reference to FIGS. 5 to 6, except for closing the gate valve 93, instead of attaching the lower lid 24. Therefore, repetitive descriptions thereof are omitted.

The gate-valve opening-closing device 94 can open and close the gate valve 93 while the interior space 20 of the purge container 1 is kept in a sealed condition, thus preventing the ambient air from entering the purge container 1. Further, the submersible pump 2 can be safely carried in and out of the liquefied-gas storage tank 5 via the purge container 1 provided on the upper portion of the pump column 3. In addition, the gate-valve opening-closing device 94 is suspended from the lower portion of the container body 21, and thus there is no load applied from above. Therefore, it is not necessary to increase the strength of the gate-valve opening-closing device 94, and a compact and lightweight gate-valve opening-closing device can be employed.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

### INDUSTRIAL APPLICABILITY

The present invention is applicable to a purge container for exposing a submersible pump for pressurizing a liquefied gas, such as liquefied natural gas (LNG), or liquid hydrogen, to purge gas. Further, the present invention is applicable to a method of exposing the submersible pump to the purge gas using such a purge container.

### REFERENCE SIGNS LIST

1 purge container
2 submersible pump
3 pump column
5 liquefied-gas storage tank
6 suction valve
8 purge-gas introduction port
9 liquefied-gas discharge port
12 elevating device
13 cable
14 hoisting device
20 interior space
21 container body
23 upper lid
23a hole
24 lower lid
27 purge-gas inlet port
28 purge-gas outlet port
34 upper flange
35 inlet valve
36 outlet valve
38 purge-gas supply line
39 purge-gas outlet line
40 purge-gas supply source
45 pump suspension mechanism
46 coupling member
47 stopper
50 coupling link
51 suspension cable
54 bolt
55 nut
58 side lid
60 lower flange
68 purge index measuring device
70 side wall
70A inner wall
70B outer wall
71 space
72 vacuum line
73 sealing cover
74 space
75 sealing member
77 inner elevating device
77A pump hoisting device
77B elevation handle
78 door opening-closing device
78A door drive mechanism
78B opening-closing handle
80 door structure
84 door cable
88 first engagement member
89 second engagement member
93 gate valve
94 gate-valve opening-closing device
94A screw driving mechanism
94B opening-closing handle
94C screw drive mechanism
94D opening-closing motor
100 outer shell
101 column lid
102 space

1. A purge container for exposing a submersible pump to purge gas, the submersible pump being used to deliver liquefied gas, the purge container comprising:
a container body having an interior space for accommodating the submersible pump therein, the container body being secured to an upper portion of a pump column in which the submersible pump is to be installed;
an upper lid configured to cover an upper opening of the container body;
a lower lid configured to cover a lower opening of the container body; and
a purge-gas inlet port and a purge-gas outlet port communicating with the interior space of the container body.

2. The purge container according to claim 1, further comprising a side lid configured to close an opening formed in a side wall of the container body.

3. The purge container according to claim 1, further comprising:
an inlet valve coupled to the purge-gas inlet port; and
an outlet valve coupled to the purge-gas outlet port.

4. The purge container according to claim 1, further comprising a pump suspension mechanism removably attached to the upper lid, the pump suspension mechanism being configured to suspend the submersible pump within the interior space.

5. The purge container according to claim 4, wherein
the pump suspension mechanism includes a coupling member coupled to the submersible pump, and a stopper engaged with the coupling member, and
the upper lid has a hole having a shape that does not allow the stopper to pass through the hole.

6. The purge container according to claim 1, wherein the lower lid is configured to support the submersible pump.

7. The purge container according to claim 1, wherein the lower lid is removably attached to the container body.

8. The purge container according to claim 1, wherein the container body has a side wall with a heat-insulating structure.

9. The purge container according to claim 1, wherein the lower lid is composed of a door structure,
the purge container further comprises a door opening-closing device configured to open and close the door structure, and
the door opening-closing device includes a door drive mechanism which is arranged in the interior space and coupled to the door structure.

10. The purge container according to claim 1, further comprising an inner elevating device configured to elevate and lower the submersible pump, the inner elevating device including a pump hoisting device arranged in the interior space.

11. The purge container according to claim 1, wherein the lower lid is composed of a gate valve, and
the purge container further comprises a gate-valve opening-closing device configured to open and close the gate valve.

12. A method of using a purge container for exposing a submersible pump to purge gas, the submersible pump being used to deliver liquefied gas, the method comprising:
accommodating the submersible pump in an interior space of a container body of the purge container which is secured to an upper portion of a pump column; and
filling the interior space accommodating the submersible pump with purge gas.

13. The method according to claim 12, wherein the liquefied gas comprises liquid hydrogen, and the purge gas comprises a gas having a boiling point lower than a boiling point of hydrogen.

14. The method according to claim 12, further comprising expelling the liquefied gas from the pump column before accommodating the submersible pump in the purge container.

15. The method according to claim 12, further comprising expelling the liquefied gas from the pump column after accommodating the submersible pump in the purge container.

16. The method according to claim 12, further comprising lowering the submersible pump from the purge container into the pump column by an elevating device.

17. The method according to claim 16, further comprising pulling up the submersible pump out of the pump column into the purge container by the elevating device while supplying purge gas into the interior space of the purge container.

18. The method according to claim 17, further comprising filling the interior space accommodating the submersible pump with purge gas after the submersible pump is pulling up into the purge container.

19. The method according to claim 18, further comprising removing the submersible pump from the purge container.
